(19) United States
(12) Patent Application Publication
(10) Pub. No.: US 2016/0034994 A1
(43) Pub. Date: Feb. 4, 2016

(54) SYSTEM AND METHOD OF APPLYING THIRD PARTY DONATIONS TO A DONEE MERCHANT ORDER

(71) Applicant: Wal-Mart Stores, Inc., Bentonville, AR (US)

(72) Inventor: David Soldate, Bentonville, AR (US)

(21) Appl. No.: 14/810,697

(22) Filed: Jul. 28, 2015

Related U.S. Application Data
(60) Provisional application No. 62/030,396, filed on Jul. 29, 2014.

(51) Int. Cl. G06Q 30/06; G06Q 20/40; G06Q 20/12; G06Q 20/02

(52) U.S. Cl. CPC G06Q 30/0613; G06Q 20/02; G06Q 20/405; G06Q 30/0635; G06Q 20/12

(57) ABSTRACT

The present disclosure relates to methods of and systems for applying third party donations to an order placed by a donee. Donation data including a total donation amount is received from a donor. At least one order from a preexisting set of orders is selected to which at least a portion of the total donation amount is to be applied, the selecting being based on selection criteria. The portion of the total donation amount is applied to the selected at least one order. A residual donation amount may be determined as the difference of the total donation amount and the portion of the total donation amount applied. The donor and/or donee may be notified of the donation and residual donation amount.

### RELATED APPLICATIONS

This application claims priority to U.S. Provisional Application Ser. No. 62/030,396 filed on Jul. 29, 2014, the disclosure of which is incorporated by reference herein in its entirety.

### BACKGROUND

In various cultural contexts, people will provide gifts to one another. Some such gifts take the form of a donation which may be made on behalf of the donee to a merchant or other party by the donor. Such gifts may provide certain benefits to the donor such as the ability to make anonymous gifts to un-expecting third parties.

Around holidays, back to school shopping, and other events, donors will often pay for layaway items ordered by other customers. However, it can be difficult for a donor to know characteristics of the donee, such as the financial need of the donee, purpose of the items to be purchased, age of the recipients of the goods (if they are being purchased as gifts by the donee), and other information that may inform a donors gifting decision.

Accordingly, there is a need for a system and method to allow for the efficient sorting of donee orders for donors to make donation decisions.

### SUMMARY

Embodiments described herein provide systems and methods for advantageously applying third party donations to donee merchant orders. The systems and methods can provide for a computerized improvement to the functioning of the computer by being able to donate to specific pre-existing orders and initiating automatic shipment of the order to a specified address once a total balance of the order has been paid. Exemplary embodiments can automatically suggest items to donate, which reduces the burden on the servers and database(s) by reducing the number of queries performed to search for individual products, creating an order for applying donations and shipping order to a specified address. Rather, the described embodiments require minimal searches by applying donations to entire pre-existing orders and automatically shipping the orders to a specified address. This reduction in resource consumption is specifically advantageous for environments that receive and process high volumes data traffic, which can result in malfunction of servers and database systems.

Exemplary embodiments described herein present a method to apply third party donations by a donor to a donee merchant order comprising of entering on a computing device a donor account information. In exemplary embodiments the method includes, retrieving, from a database, a donor profile using the entered account information. In exemplary embodiments the method includes, creating, via the computing device, criteria to filter pre-existing orders stored in the database. In exemplary embodiments the method includes, retrieving, via the database, the pre-existing orders created by a donee based on the filter criteria. In exemplary embodiments the method includes, displaying, on a display operatively coupled to the computing device, the retrieved pre-existing orders. In exemplary embodiments the method includes, selecting, via a computing device, a pre-existing order with a remaining total balance to make a donation toward. In exemplary embodiments the method includes provide, making a donation, via a computing device, toward the selected pre-existing order; applying a donation, via a computing device, toward the selected pre-existing order. In exemplary embodiments the method includes provide, wherein applying a donation includes instructing database to adjust a total balance associated with the pre-existing order to be adjusted according to the applied donation; and refunding a residue balance back to the donor.

Exemplary embodiments described herein present a system to apply third party donations by a donor to a donee merchant order comprising of: a database and a computing device in communication with the database. The computing device retrieves, from the database, a donor profile using received account information. In exemplary embodiments, the computing device, receives, in response to user's interaction via a graphical user interface rendered on a display operatively coupled to the computing device, a selection criteria to return a subset of pre-existing orders stored in the database. In exemplary embodiments, the computing device, retrieves, from the database, the subset of pre-existing orders stored in the database in response to a database query including the selection criteria selected by the user. In exemplary embodiments, the computing device, displays, on a display operatively coupled to the computing device, the retrieved pre-existing orders. In exemplary embodiments, the computing device, selects, via the user interaction with the display rendering graphical user interface, a pre-existing order with a remaining total balance to make a donation toward. In exemplary embodiments, the computing device, receives, a donation toward the selected pre-existing order. In exemplary embodiments, the computing device, applies a donation toward the selected pre-existing order. In exemplary embodiments, the computing device, refunds a residue balance back to the donor. In exemplary embodiments, the computing device transmits an update instruction to the database instructing the database to adjust a total balance associated with the pre-existing order according to the applied donation.

In exemplary embodiments, the filter criteria can include one of: non-profit status of the donee; tax deductibility of donations to the donee; types of goods ordered by the donee; geographical location of the donee; availability of the goods needed to fulfill the order based upon data from; an inventory tracking system; association of the order with an event; number of third party; donations previously applied to the order; total value of the order; and elapsed time since the order was created.

In exemplary embodiments, the residue balance can be a resultant of a difference of a total donation amount and the portion of a total donation amount applied.

In exemplary embodiments, the residue balance can be applied to additional pre-existing orders.

In exemplary embodiments, the methods and systems provide for selecting the pre-existing order at random.

In exemplary embodiments, the methods and systems provide for selecting multiple pre-existing orders.

In exemplary embodiments, the methods and systems provide for applying donation towards multiple pre-existing orders.

In exemplary embodiments, the applied donation can be a percentage of the total balance of the pre-existing order.

In exemplary embodiments, the methods and systems provide selecting includes creating a listing of eligible pre-existing orders based on the selection criteria.

In exemplary embodiments, the methods and systems provide for selecting at least one of the orders selected from the listing of eligible orders generated among which the total donation amount will be divided.

Any combination and/or permutation of embodiments is envisioned. Other embodiments, objects, and features will become apparent from the following detailed description considered in conjunction with the accompanying drawings. It is to be understood, however, that the drawings are designed as an illustration only and not as a definition of the limits of the present disclosure.

### BRIEF DESCRIPTION OF DRAWINGS

Illustrative embodiments are shown by way of example in the accompanying drawings and should not be considered as a limitation of embodiments of the present disclosure:

FIG. 1 is a block diagram of an example computing device used to create orders by donee and make donations by the donor in accordance with example embodiments of the present disclosure.

FIG. 2 illustrates an exemplary environment through which the computing device communicate with other devices.

FIG. 3 is a flowchart describing the process of creating orders for donation by the donee according to an exemplary embodiment.

FIG. 4 is a flowchart describing the process of making donations by the donor according to an exemplary embodiment.

FIG. 5 illustrates the software routines and database calls of making donations by the donor according to an exemplary embodiment.

### DETAILED DESCRIPTION OF EXEMPLARY EMBODIMENTS

Described in detail herein are methods, and systems associated with applying third party donations to a donee merchant order. In exemplary embodiments, a merchant donee can create an order and save the order. In exemplary embodiments, a donor can apply a donation toward a specific pre-existing order created by the donee. In exemplary embodiments, once the total balance of the order has been paid the order may be automatically shipped to a specified address or picked up at the store by the donee. Exemplary embodiments search for pre-existing orders and automatically ship the orders to a specified address reduces the number of queries executed by the servers and databases. This reduction in resource consumption is specifically advantageous for environments that receive and process high volumes data traffic, which can result in malfunction of servers and database systems.

The following description is presented to enable any person skilled in the art to create and use systems, related methods associated with applying third party merchant donations to donee merchant orders. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that example embodiments of the present disclosure may be practiced without the use of these specific details. In other instances, well-known structures and processes are shown in block diagram form in order not to obscure the description of example embodiments with unnecessary detail. Thus, the present disclosure is not intended to be limited to the embodiments shown, but is to be accorded the widest scope consistent with the principles and features disclosed herein.

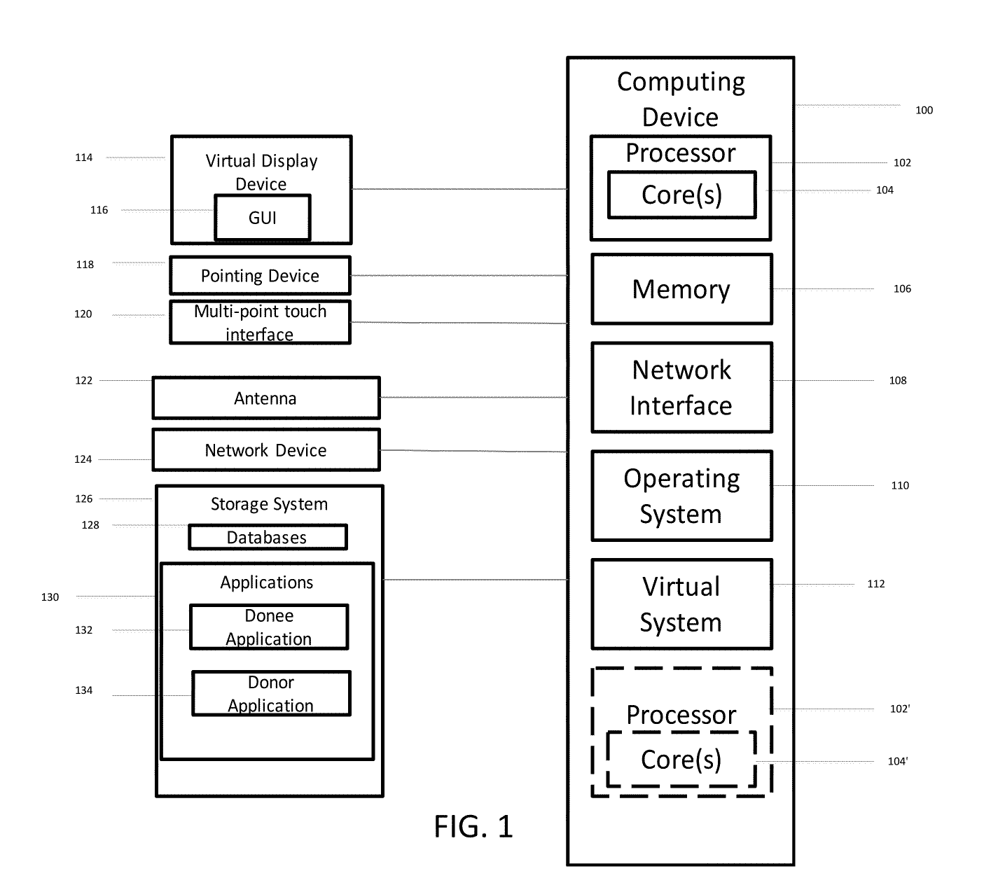

FIG. 1 is a block diagram of an example computing system 100 that may be used to implement exemplary operations of the creating orders by the donee and making donations by the donor, with the present disclosure. The computing device 100 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 106 included in the computing device 100 may store computer-readable and computer-executable instructions or software for implementing exemplary operations of the computing device 100. The computing device 100 also includes configurable and/or programmable processor 102 and associated core(s) 104, and optionally, one or more additional configurable and/or programmable processor(s) 102′ and associated core(s) 104′ (for example, in the case of computer systems having multiple processors/cores), for executing computer-readable and computer-executable instructions or software stored in the memory 106 and other programs for controlling cashier station 100 components operatively coupled to the computing system 100. Processor 102 and processor(s) 102′ may each include a central processing unit (CPU) and may each be a single core processor or multiple core (104 and 204′) processor.

Virtualization may be employed in the computing system 100 so that infrastructure and resources in the computing system 100 may be shared dynamically. A virtual machine 112 may be provided to handle a process running on multiple processors so that the process appears to be using only one computing resource rather than multiple computing resources. Multiple virtual machines may also be used with one processor.

Memory 106 may include a computer system memory or random access memory, such as DRAM, SRAM, EDO RAM, and the like. Memory 106 may include other types of memory as well, or combinations thereof.

A user (e.g., a cashier) may interact with the computing system 100 through a visual display device 114, such as a computer monitor, which may display one or more graphical user interfaces 116, multi touch interface 120, and a pointing device 118.

The computing device 100 may also include one or more storage devices 126, such as a hard-drive, CD-ROM, or other computer readable media, for storing data and computer-readable instructions and/or software that implement exemplary of the computing device (e.g., applications 130 including a donee application 132, a donor application 134). In exemplary embodiments, upon execution of the donee application 132 by the processor 102, the processor 102 can provide one or more graphical user interfaces through which a donee can select items and can create an order in response to selection of the items via the graphical user interfaces. The donee may save the order and access the order using the donee application 132. In exemplary embodiments, upon execution of the donor application 134 by the processor 102, the processor 102 can provide one or more graphical user interfaces through which a donor can search for, select and donate towards pre-existing orders. In exemplary embodiments, the donor application 134 may allow the donor to filter the search of pre-existing orders, and donate to single or multiple pre-existing orders. The donor application 134 can be executed by the processor to refund the donor any residue money. Exemplary storage device 126 may also store one or more databases 128 for storing any suitable information required to implement exemplary embodiments. For example, exemplary storage device 126 can store one or more databases 128 for storing information such as pre-exiting orders created by the donee. The databases may be updated manually or automatically at any suitable time to add, delete, and/or update one or more data items in the databases.

The computing device 100 can include a network interface 108 configured to interface via one or more network devices 124 with one or more networks, for example, Local Area Network (LAN), Wide Area Network (WAN) or the Internet through a variety of connections including, but not limited to, standard telephone lines, LAN or WAN links (for example, 802.11, T1, T3, 56kb, X.25), broadband connections (for example, ISDN, Frame Relay, ATM), wireless connections, controller area network (CAN), or some combination of any or all of the above. In exemplary embodiments, the computing device can include one or more antennas 122 to facilitate wireless communication (e.g., via the network interface) between the computing device 100 and a network. The network interface 108 may include a built-in network adapter, network interface card, PCMCIA network card, card bus network adapter, wireless network adapter, USB network adapter, modem or any other device suitable for interfacing the computing device 100 to any type of network capable of communication and performing the operations described herein.

The computing device 100 may run any operating system 110, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device 100 and performing the operations described herein. In exemplary embodiments, the operating system 110 may be run in native mode or emulated mode. In an exemplary embodiment, the operating system 110 may be run on one or more cloud machine instances.

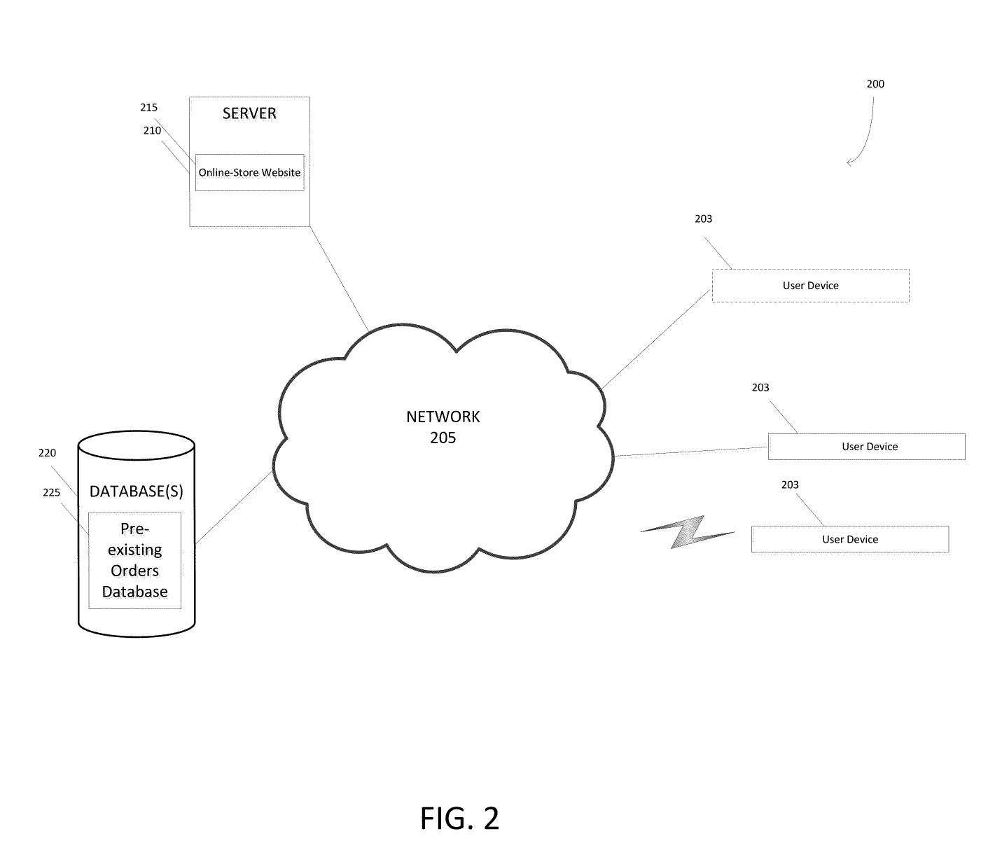

FIG. 2 illustrates a network diagram depicting a system 200 for applying third party donations to donee merchant orders. The system 200 can include a network 205, user devices 203, a server 210, and the database(s) 220. Each of the user devices 203, the server 210, and the database(s) 220 is in communication with the network 205.

In an example embodiment, one or more portions of network 205 may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The user devices 203 can be implemented as an embodiment of the computing device 100 (shown in FIG. 1) and may comprise, but are not limited to, work stations, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, network PCs, mini-computers, smartphones, tablets, netbooks, and the like. The user devices 203 may be used be the donee to create the orders (e.g., upon execution of a donee application 132 by the processor 102). In other embodiments, the user devices 203 can be used by the donor to make the donation (e.g., upon execution of a donor application 134 by the processor 102).

The user devices 203 may also include various external or peripheral devices to aid in performing transactions such as creating orders by the donee and making a donation towards a pre-existing order. Examples of peripheral devices include, but are not limited to, barcode scanners, cash drawers, monitors, touch-screen monitors, clicking devices (e.g., mouse), input devices (e.g., keyboard), receipt printers, payment terminals, and the like. Examples of payment terminals include, but are not limited to, card readers, pin pads, signature pads, signature pens, Square™ registers, LevelUp™ platform, cash or change deposit devices, cash or change dispensing devices, coupon accepting devices, and the like.

The user devices 203 may connect to network 205 via a wired or wireless connection. The user devices 203 may include one or more applications or systems. In an example embodiment, the user devices 203 may perform all the functionalities described herein.

In some embodiments , the user devices 203 may perform some of the functionalities, and server 210 performs the other functionalities described herein. For example, the user devices 203 may generate a user interface in response to execution of the donee application 132 and/or the donor application 134. In an another embodiment the server 210 may generate a user interface in response to execution of the donee application 132 and/or the donor application 134. In exemplary embodiments, the graphical user interface for the donee application 132 presents donee with the functionality of selecting various items and creating an order. The graphical user interface for the donee application 132 may also allow the donee to save the order. In exemplary embodiments, the graphical user interface for the donor application 134 presents the donor with the functionality of searching for pre-existing orders created by a donee. The graphical user interface of the donor application 132 may allow the donor to filter the search results, and select a single or multiple pre-existing orders to make a donation towards.

The server 210 may query the databases to retrieve pre-existing orders created by the donee. The server 210 may host the online-store 215. In exemplary embodiments, the donee application 132 and donor application 134 may interface with the online-store 215 to allow the donee and donor to create pre-existing orders, search for pre-existing orders and make donations towards pre-existing orders accordingly. In exemplary embodiments, the donee using the donee application 132 may interface with the online store 215 to select items and save a pre-existing order. In exemplary embodiments the donor may interface with the online-store using the donor application 134 to search for and donate towards pre-existing orders.

The database(s) 220 may store data related to the products and users as described herein. The database(s) 220 include the pre-existing orders database created by the donee 225. In exemplary embodiments, a donee creates an order using the donee application 132. The order is stored in the pre-existing orders database 225. A total balance due associated with the order may be stored in the pre-existing orders database 225. The donor, using the donor application 132, may retrieve pre-existing orders stored in in the pre-existing orders database 225 based on filtered criteria. The donor may make a donation toward a retrieved pre-existing order and the donation invokes an update of the total balance due. The new balance due stored in the pre-existing orders database reflects the difference of the previous balance due and the donation made by the donor. In exemplary embodiments, if the entire balance of the order has been paid the pre-existing orders database 225 may be updated to reflect that the order has been paid and is ready to be shipped.

Each of the server 210 and database(s) 220 is connected to the network 205 via a wired connection. Alternatively, one or more of the server 210 and databases 220 may be connected to the network 205 via a wireless connection. Server 210 comprises one or more computers or processors configured to communicate with the user devices 203 and/or the database(s) 220, via network 205. Server 210 hosts one or more applications or websites accessed by the user devices 203 and/or facilitates access to the content of database(s) 220. Server 210 also may include online-store 215. Database(s) 220 comprise one or more storage devices for storing data and/or instructions (or code) for use by server 210, and/or the user devices 203. Database(s) 220 and server 210 may be located at one or more geographically distributed locations from each other or from the user devices 203. Alternatively, database(s) 220 may be included within server 210.

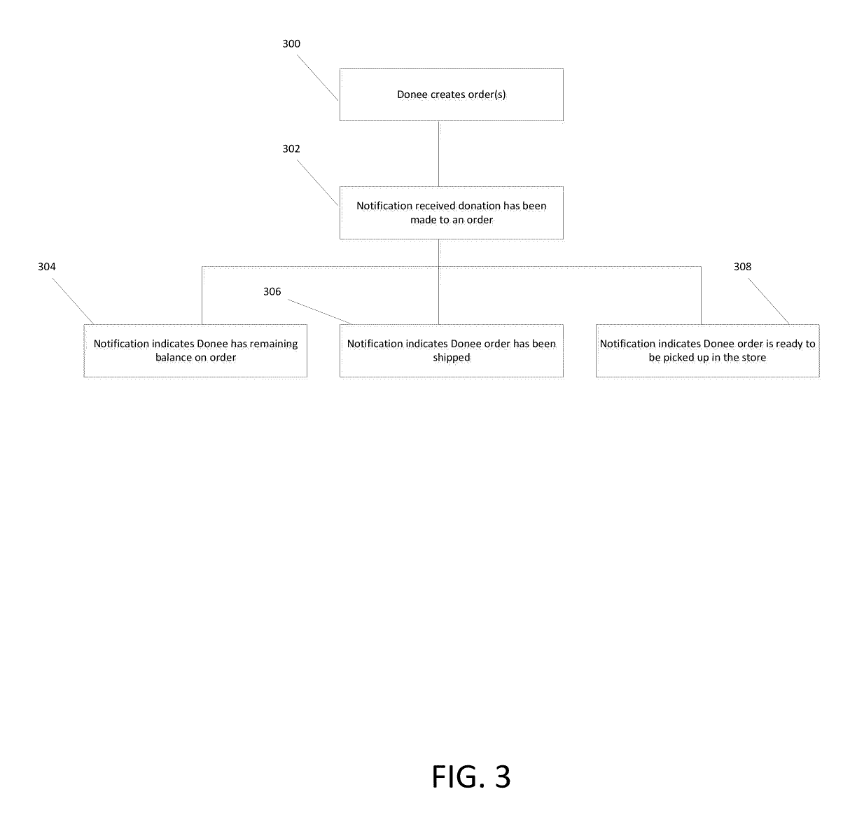

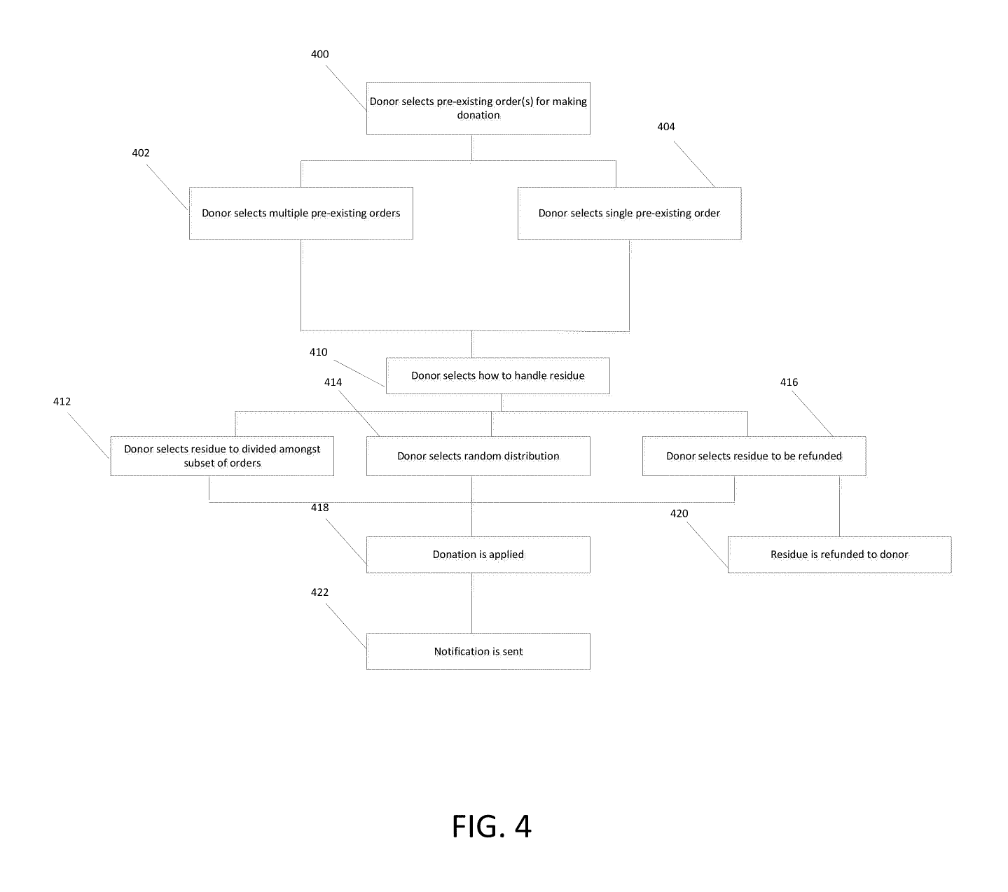

FIG. 3 is a flow chart illustrating the process of the donee creating a merchant order available for donation upon execution of an embodiment of the donee application by a processor of a computing device. In exemplary embodiments, in operation 300, the processor receives a selection of items for an order in response to an interaction between a user and a user interface operatively coupled to the processor and creates an order available for donation, which is stored in a database. In exemplary embodiments the order can be created in a physical store (e.g., at a point-of-sale terminal including an embodiment of the computing device 100 shown in FIG. 1 and executing the donee application 132) by or on-behalf of a donee. In another embodiment, the order can be created on a website hosting the online store by a donee or on behalf of a donee (e.g., a user device can access a server implemented as an embodiment of the computing device 100 shown in FIG. 1 executing the donee application 132). In exemplary embodiments, a donee can be a non-profit organization, charitable organization, or an individual. After the order has been created, potential donors can view and access information about the order including the items included in the order, the beneficiary of the order, the creator of the order, and the like. A potential donor can donate to the order according to, for example, an exemplary donor process, such as an embodiment of the donor process described herein with reference to FIG. 4.

In operation 302, a notification is received by the donee that a donation has been made towards a pre-existing order. In exemplary embodiments, once a donation (as discussed in FIG. 4) has been made toward a pre-existing order the pre-existing order may be flagged. In exemplary embodiments, the processor receives donations made toward pre-existing orders and creates a notification to be transmitted to the donee. In exemplary embodiments, the pre-existing orders database 225 may store donee information. In exemplary embodiments, the donee may receive the notification on the user device 203. The notification may be sent in various forms including but not limited to of an e-mail, SMS message, MMS message, and RSS. In exemplary embodiments, the donee may receive the notification using the donee application 132. In exemplary embodiments, the donee can accept the donation or reject the donation. If the donee accepts the donation the amount of the donation is deducted from balance of the order. In exemplary embodiments, the processor receives an acceptance of donation from donee and instructs the total balance for the pre-existing order updated in the pre-existing orders database 225.

In operation 304, the notification includes the total balance remaining for the order. In exemplary embodiments, the server 210 may retrieve the updated total balance for the pre-existing order and transmit the total balance due to the donee's user device 203. The user device 203 may display the updated total balance on the display 114 of the user device 203. In exemplary embodiments, in operation 306, if the total balance has been paid the notification informs the donee that the order has been shipped to a specified address. The pre-existing orders database 225 may store a specified address entered by the donee correlated with the pre-existing order. In exemplary embodiments, once the total balance has been paid the database entry for the pre-existing order may be flagged as paid. The server 210 may ship all paid pre-existing orders to the specified address stored in the pre-existing orders database. The server 210 may transmit a notification to the donee's user device 203 notifying the donee the total balance has been paid and been shipped to the specified address. The user device 203 may display the notification on the display 114. Alternatively, in operation 308 the server 210 can ship the pre-existing order to a specified store and send a notification to the donee informing the donee that the order is ready for in-store pick up at the specified store.

FIG. 4 is a flowchart illustrating the process for a third party donor to apply a donation towards a donee's pre-existing order upon execution of an embodiment of the donor application by a processor of a computing device. In exemplary embodiments, in operation 400 the donor may select a pre-existing order to make a donation. In exemplary embodiments, the processor may retrieve multiple pre-existing orders from the server 210. In exemplary embodiments, at least one order from a preexisting set of orders may be selected, the selecting being based on selection criteria. In some embodiments, the selection criteria may include but is not limited to the non-profit status of the donee; tax deductibility of donations to the donee; types of goods ordered by the donee; geographical; location of the donee; availability of the goods needed to fulfill the order based upon data from; an inventory tracking system; association of the order with an event; number of third party; donations previously applied to the order; total value of the order; and elapsed time since the order was created. The selection criteria may include order specific data sufficient to identify the order. In exemplary embodiments, the sever 210 may query the database 220 for pre-existing orders meeting the selection criteria defined by the donor. The database 220 may execute a query against the pre-existing orders database 225 and transmit returned pre-existing orders to the server 210. The server 210 may sequence the pre-existing orders and transmit the orders to the donor's user device 203. The pre-existing orders may be displayed on the donor's user device 203. In exemplary embodiments the donor can search for a pre-existing order in a physical store (e.g., at a point-of-sale terminal including an embodiment of the computing device 100 shown in FIG. 1 and executing the donor application 134) by or on-behalf of a donor. In another embodiment, the donor may search for a pre-existing order a website hosting the online store 215 by a donor or on behalf of a donor (e.g., a user device can access a server implemented as an embodiment of the computing device 100 shown in FIG. 1 executing the donor application 134).

In exemplary embodiments, a donor, using the donor application 134, may be allowed to create filter criteria that will be used to filter potential donee orders and create a subset of available orders that have a remaining balance. In exemplary embodiments the criteria may include, events: A retail event can be holidays, such as Christmas, or special events such as back to school; non-profit: orders associated to a non-profit organization; locale: a set of customer orders that are within a specific location such as zip code, city, state or country; product categories: a set of customer orders that contain specific types of products such as toys or food; order amount ranges: a set of customer orders where the total order cost is within a set range. In exemplary embodiments the filtered may be sequenced. In exemplary embodiments the processor 102 may receive the filter criteria and transmit the filter criteria to the server 210. The server 210 may filter the pre-existing orders using the filter criteria provided by the donor. In exemplary embodiments, sequencing may be done, on the sever 210, by the customer order number, by the balance due or by the total order amount. Each of these sequences may be ascending or descending. In exemplary embodiments, the donor application 134 can provide an option can to enable further limiting the subset to only include those active orders that have never had a donation applied to them. The processor 102 may transmit the further limiting criteria to the server 210. The server 210 may apply the further limiting criteria on the pre-existing orders. In exemplary embodiments, the donor may be able to indicate that they wish a set amount to be used on a single order or to be applied against multiple orders either by amount or by percentage. In exemplary embodiments, the donor may chose to donate to randomized orders which meet the filter criteria determined by the donor.

In operation 402, the donor may indicate they wish to distribute donation to multiple orders by percentage. In exemplary embodiments, the donor may select multiple pre-existing orders using the donor application 134. The donor donate to multiple pre-existing orders by designating a certain percentage or a specific amount to be donated among multiple pre-existing orders. The processor 102 may receive the donation for each individual pre-exiting order in response to the donor's interaction with the user interface of the donor application 134 and transmit the donations to the server 210. In exemplary embodiments, the server 210 may retrieve donee for the pre-existing orders and transmit notifications to the donee as described in FIG. 3. In exemplary embodiments, the donor may set a maximum value that can be applied toward a specific order by a set amount or by percentage. In an example, a donor may donate $1,000 and wish to have $100 applied to 10 different orders. In another example the donor may donate #100 and express they wish to have an order receive no more than 25% of the total or $25.

In exemplary embodiment the merchant may have the option to establish minimum and maximum donation amounts for either the donor or individual orders. In an example, a donor may need to donate a minimum of $25 and a single order must receive at least a $5 donation.

In exemplary embodiments, in operation 404, the donor may indicate they wish to donate to a single pre-existing order. In exemplary embodiments the donor may select a single pre-existing order using the donor application 134. In exemplary embodiments, the donor can donate a specific amount toward a pre-existing order or donate a percentage of a total balance remaining on the order. The processor 102 may receive the donation amount in response to the donor's interaction with the user interface of the donor application 134 and transmit the donation amount to the server 210. The server 210 may retrieve donee information for the pre-existing order from the pre-existing orders database 225 and send a notification to the donee regarding the donation as described in FIG. 3. In exemplary embodiments donor can select a random pre-existing order for donation. The processor 102 may receive a request from the donor to select a random pre-existing order in response to the donor's interaction with the user interface of the donor application 134 . The processor 102 may communicate this request with the server 210. The server 210 may select a randomized database entry from the pre-existing orders database 225 and transmit the randomly selected pre-existing order to the donor application 134.

In operation 410, the donor may selects how to handle residue balance. The residue balance may be defined the difference between the balance due on the donee order(s) and the amount of donation that is applied against that order. The processor 102 may receive instructions in response to the donor's interact with the user interface of the donor's application 134 on how to process the residue balance. The processor 102 may transmit the instructions to the server 210.

In operation 412, the donor may select the residue balance to be divided amongst a specific subset of pre-existing orders. In exemplary embodiments the processor 102 may transmit instructions to the server 210 to divide the residue balance among selected multiple pre-existing orders. The donor may select and donate to multiple pre-existing orders as described above in FIGS. 4 400 and 402. In exemplary embodiments, the donor may choose to only donate the residue balance to a single pre-existing order. The processor 102 may transmit instructions to the server 210 to donate the residue balance to a single pre-existing order. The donor may select and donate to a single pre-existing order as described above in FIGS. 4 400 and 404.

In operation 414, the donor may select the residue to be divided amongst a random pre-existing order(s). The processor 102 may instruct the server 210 to divide the residue amongst randomly selected pre-existing orders. The server 210 may query the pre-existing orders database 225 for randomly selected pre-existing orders with balances that will accommodate the residue balance.

In operation 416, the donor may select the residue be refunded back to the donor. In exemplary embodiments, the processor 102 may receive a request to refund the residue balance In exemplary embodiments, in operation 420 the donor may have chosen not to have the residue applied to additional, or future pre-existing orders or there may be an amount remaining that may be refunded to the donor. This remaining amount will be refunded back to the donor. In exemplary embodiments, the server 210 can determine if the tender used was a bank card, then the remaining amount can be refunded back to the original tender. In exemplary embodiments, if the tender was cash, gift card or another form of tender that cannot be systematically refunded, then a gift card or post card can be sent to the donor with instructions on how to obtain their refund. Additionally, after validation of the original tender, an electronic payment in the amount of the refund residue may be made to the donor.

In operation 418, the donation is applied to the total amount of the respective order(s). The amount of the donation is deducted from the total balance of the order. The new total balance for the order is updated in the database 220. The processor 102 can receive a request to donate the amount designated by the donor in response to the donor's interaction on the user interface of the donor application 134. The processor 102 may send instructions the server 210 to update the total balances of the respective pre-existing order(s). The donation amount may include the initial donation and any donation made using the residue balance. The server 210 may communicate with the database 220 to update the total balance of the pre-existing orders stored in the pre-existing orders database 225. In operation 422, the server 210 may send out notifications to the donee with the updated total balance as described in FIG. 3.

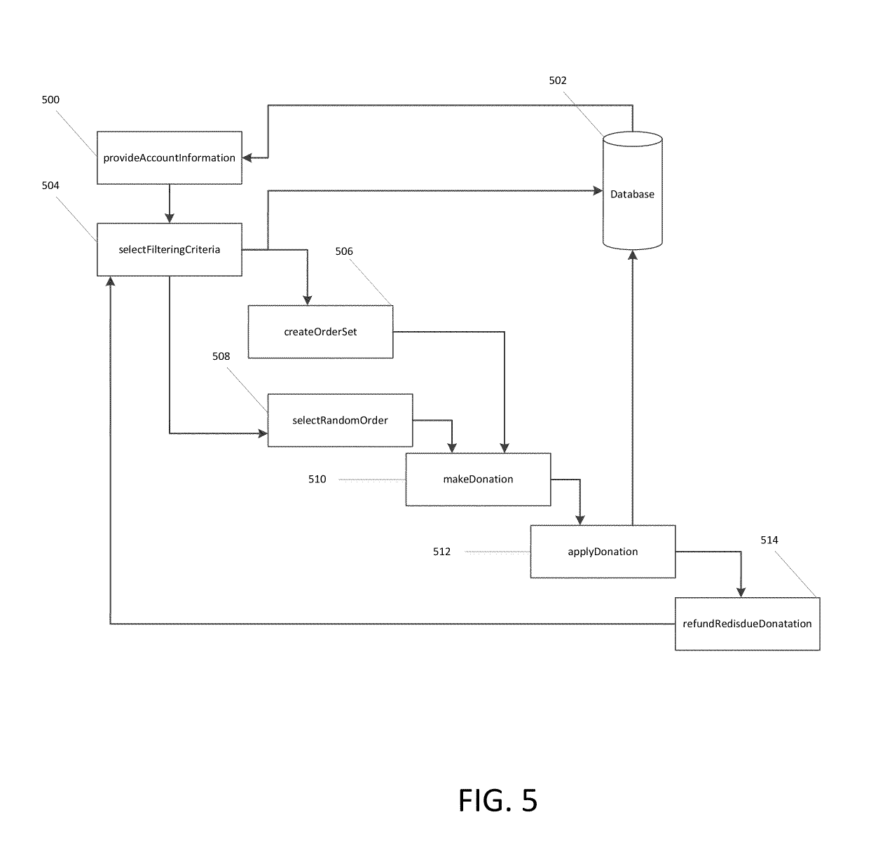

FIG. 5 illustrates software routines and database calls for making donations by a donor via, e.g., execution of a donor application 134 according to an exemplary embodiment. In exemplary embodiments, in software routine provideAccountlnformation 500, a processor 102 controls a display device to render a graphical user interface that allows the donor to enter account information which is then is used by the processor 102 to retrieve a donor profile from a database 502. A software routine selectingFilteringCriteria 504 can be called by the provideAccountlnformation 500 of another software routine upon authentication of the account information. Upon execution of the software routine selectingFilteringCriteria 504, the processor 102 can control a display device to render a graphical user interface through which the donor can select a type of donee(s) and type of pre-existing orders to which donation is to be made. For example, the software routine selectingFilteringCriteria 504 can retrieve donee types and order types from the database and can provide selectable objects in the graphical user interface that allow the donor to select desired donee types and/or order types. In response to the selections (e.g., filter criteria), the software routine selectingFilteringCriteria 504 can be executed by the processor 102 to construct a database query based on the filter criteria including the selected donee types and/or order types, and retrieve based on the database query, the appropriate donee(s) and pre-existing orders stored in the database 502.

In some embodiments, a software routine createOrderSet 506 can be called by the software routine selectingFilteringCriteria 504 and/or another software routine that allows the donor to create a subset of orders based on the filtering criteria. As one non-limiting example, the software routine createOrderSet 506 can create a container or object, and the donor can select orders to add to the container or object to create a subset of orders to which the donor desires to make a donation.

In some embodiments, a software routine selectRandomOrder 508 can be called by the software routine selectingFilteringCriteria 504 and/or another software routine that randomly selects a pre-existing order for the donor. As a non-limiting example, the software routine selectRandomOrder 508 can create a container or object and can add the order to the container or object.

A software routine makeDonation 510 can be called by the software routine selectingFilteringCriteria 504, the software routine selectRandomOrder 508, and/or another software routine that allows the donor may make a donation towards a selected pre-existing order(s).

A software routine applyDonation 512, called by the software routine makeDonation 510, can apply the donor's donation toward the pre-existing order(s). For example, in exemplary embodiments, in software routine applyDonation 512, the database 502 storing the pre-existing orders is updated with the applied donation. The software routine applyDonation 512 may receive the amount of donation made by donor from the software routine makeDonation 510. The applyDonation 512 may calculate the updated total balance of a pre-existing order by taking a the difference of the previous total balance and the donation made by the donee. The applyDonation 512 may transmit an update instruction including the updated total balance to the database 502 to update the total balance of a pre-existing order based on the donation. A total balance stored in the database 502 associated with respective pre-existing order is updated to reflect the donation made by the donor. In exemplary embodiments, if the applyDonation calculates the resultant balance the pre-existing order is equal to 0, the pre-an update instruction is transmitted the database 502 to mark the pre-existing order paid and, and to flag the database entry for the pre-existing order stored in the database as ready to be shipped to a specified address associated with the pre-existing order. In another embodiment, when the pre-existing order is marked as paid, the pre-existing order is flagged in the database as ready to be picked up at specified store location associated with the pre-existing order. The software routine applyDonation may calculate if the donor has any residue balance after the donation has been applied. The software routine may transmit the residue balance to the software routine refundResidueDonation 514.

In some embodiments, in software routine refundResidueDonation 514 called by the software routine applyDonation 512 the donor may select to have the residue donation refunded back to the donor. In some embodiments the donor may also chose to apply the residue donation toward other pre-existing orders by calling the selectFilteringCriteria 504 software routine.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

What is claimed is:

1. A method to apply third party donations by a donor to a donee merchant order comprising of:
receiving donor account information from a user via a graphical user interface render an a display in response to execution of a first software routine;
retrieving, from a database, a donor profile in response to a database query generated based on the account information;
receiving, from a user via the graphical user interface rendered on a display, selection criteria to return a subset of pre-existing orders stored in the database;
retrieving, from the database, the subset of pre-existing orders stored in the database in response to a database query including the selection criteria selected by the donor ;
displaying, on a display operatively coupled to the computing device, the retrieved pre-existing orders;
receiving, via the computing device, selection of a pre-existing order with a remaining total balance to make a donation toward;
receiving, a donation, via a computing device, toward the selected pre-existing order;
applying a donation, via a computing device, toward the selected pre-existing order;
wherein applying a donation includes transmitting an update instruction to the database instructing the database to adjust a total balance associated with the pre-existing order according to the applied donation; and
refunding a residue balance back to the donor.

2. The method of claim 1, wherein the filter criteria includes one of: non-profit status of the donee; tax deductibility of donations to the donee; types of goods ordered by the donee; geographical location of the donee; availability of the goods needed to fulfill the order based upon data from; an inventory tracking system; association of the order with an event; number of third party donations previously applied to the order; total value of the order; and elapsed time since the order was created.

3. The method of claim 1, wherein the residue balance is a resultant of a difference of a total donation amount and the portion of a total donation amount applied.

4. The method of claim 3, further comprising applying the residue balance to additional pre-existing orders.

5. The method of claim 1, wherein the pre-existing order is selected at random.

6. The method of claim 1, wherein receiving selection of a pre-existing order comprises selecting multiple pre-existing orders.

7. The method of claim 6, further comprises applying donation towards the multiple pre-existing orders.

8. The method of claim 1, wherein the applied donation is a percentage of the total balance of the pre-existing order.

9. The method of claim 1, wherein receiving selection of a pre-existing order comprises creating a listing of eligible pre-existing orders based on the selection criteria.

10. The method of claim 9, wherein receiving selection of a pre-existing order comprises receiving selection of at least one of the orders selected from the listing the subset of returned pre-existing orders.

11. A system to apply third party donations by a donor to a donee merchant order comprising of:
a database;
a computing device in communication with the database, the computing device (i) retrieves, from the database, a donor profile using received account information; (ii) receives, in response to user's interaction via a graphical user interface rendered on a display operatively coupled to the computing device, a selection criteria to return a subset of pre-existing orders stored in the database; (iii) retrieves, from the database, the subset of pre-existing orders stored in the database in response to a database query including the selection criteria selected by the user; (iv) displays, on a display operatively coupled to the computing device, the retrieved pre-existing orders; (v) selects, via the user interaction with the display rendering graphical user interface, a pre-existing order with a remaining total balance to make a donation toward; (vi) receives, a donation toward the selected pre-existing order; (vii) apply a donation toward the selected pre-existing order; and (viii) refund a residue balance back to the donor;
wherein the computing device transmits an update instruction to the database instructing the database to adjust a total balance associated with the pre-existing order according to the applied donation.

12. The system of claim 11, wherein the filter criteria includes one of: non-profit status of the donee; tax deductibility of donations to the donee; types of goods ordered by the donee; geographical location of the donee; availability of the goods needed to fulfill the order based upon data from; an inventory tracking system; association of the order with an event; number of third party; donations previously applied to the order; total value of the order; and elapsed time since the order was created.

13. The system of claim 11, wherein the residue balance is resultant of a difference of a total donation amount and the portion of a total donation amount applied.

14. The system of claim 13, wherein the residue balance is applied to additional pre-existing orders.

15. The system of claim 11, wherein the pre-existing order is selected at random.

16. The system of claim 11, wherein the computing device selects multiple pre-existing orders.

17. The system of claim 16, wherein the computing device applies the donation towards multiple pre-existing orders.

18. The system of claim 11, wherein the applied donation is a percentage of the total balance of the pre-existing order.

19. The system of claim 11, wherein the computing device creates a listing of eligible pre-existing orders based on the selection criteria.

20. The system of claim 19, wherein receiving selection of a pre-existing order comprises receiving selection of at least one of the orders selected from the listing the subset of returned pre-existing orders.
